(19) United States
(12) Patent Application Publication
(10) Pub. No.: US 2009/0097908 A1
(43) Pub. Date: Apr. 16, 2009

(54) Dust Cover

(76) Inventors: Takashi Asa, Komaki City (JP); Yasushi Saito, Iida City (JP)

Correspondence Address: Michael L. Crapenhoft;c/o Hiroe & Associates, 4-3 Usa, 3-chome, Gifu City, 500-8368, omitted

(21) Appl. No.: 12/250,539

(22) Filed: Oct. 14, 2008

(30) Foreign Application Priority Data
Oct. 15, 2007 (JP) 2007-267316

(51) Int. Cl. F16C 11/06

(52) U.S. Cl. 403/122

(57) ABSTRACT

A dust cover is configured for use with a gas spring inside a vehicle or the like. The dust cover includes a main body portion that surrounds a socket and a cylindrical band portion integrally provided adjacent to the main body portion. The band portion surrounds an arm portion adjacent to and integral with the socket. The main body portion has an opening for receiving a ball head portion of a ball stud. The band portion has a collar portion that covers a connection portion between a base end of the arm portion and an end of a cylinder body or a connection portion between the base end of the arm portion and a distal end of a rod body.

### BACKGROUND OF THE INVENTION

The present invention relates to a dust cover and particularly to an improved dust cover for use with a ball joint in a gas spring for a rear door, a seat back, or the like of a vehicle, for example.

Various proposals have been made for dust covers for use with ball joints in gas springs for a rear door, seat back, or the like of a vehicle. One such dust cover is described, for example, in Japanese Patent Application Publication No. 2003-97540. That dust cover covers a connection portion between a socket that includes a ball joint and a ball head portion at a ball stud of the ball joint.

The ball joint has a configuration in which by a ball head portion is fitted for rotation in a socket. The dust cover used in this ball joint is, according to the disclosure in the Japanese patent publication, made of an elastic rubber material or the like. The dust cover has a substantially flared sectional shape having an opening at both ends. When the dust cover is mounted, the socket is positioned at an opening with a large diameter, and a stud portion that connects the ball head portion at the ball stud is positioned in the other opening, which has a relatively smaller diameter.

The side that has the large diameter opening in the dust cover is then fixed with a fastener such as a clip to an outer circumference of the socket so that the dust cover covers the connection portion at the ball head portion.

Thus, in the dust cover disclosed in the Japanese published patent application, since the socket into which the ball head portion is fitted and the stud portion with the ball head portion are covered by the dust cover, these parts are covered effectively without an undue amount of material being required for use in the dust cover.

Although, however, there is no major deficiency in the ability of the dust cover described in the Japanese publication to perform the covering function, some difficulties might arise when that cover is used in practice.

In particular, the dust cover disclosed in the Japanese document, has the side with the large diameter opening fixed to an outer circumference of the socket with a fastener such as a clip. The fastener is thus required to mount the dust cover, which means that two separate components are needed to use the dust cover.

In the case of the ball joint described in the published application, after the ball joint portion is fitted for rotation inside the socket, an opening end portion of the socket is sealed to guarantee the connection between the two parts.

Therefore, in the configuration proposed in the published application, after the ball joint is constructed by fitting the ball head portion into the socket and the opening end of the socket is sealed, the dust cover is fixed to the outer circumference of the socket with a fastener such as a clip. This makes the work somewhat cumbersome.

The present invention was made in view of these circumstances and is intended to provide a dust cover that can provide effective cover for other parts, including a socket to which a ball head portion is fitted, without unnecessarily increasing the number of components and not requiring excess labor, and which is effective in ensuring the effective operation of a gas spring with which the dust cover may find use.

### SUMMARY OF THE INVENTION

In view of the above, a dust cover is provided that surrounds a socket on a first end side of a cylinder body in a gas spring. The cylinder body of the gas spring can be filled with a gas. The dust cover can also be provided at a distal end side of a rod body that is inserted into and movable in and out of the cylinder body. A ball head portion of a ball stud can be fitted into a socket of the gas spring. A main body portion of the dust cover surrounds the socket, a cylindrical band portion adjacent the main body portion surrounds an arm portion that lies adjacent the socket. The main body portion of the dust cover has an opening for receiving the ball head portion of the ball stud, and the band portion has a connection portion between a base end of the arm portion and a bottom end of the cylinder portion, or a collar portion that covers the connection portion between the base end of the arm portion and the distal end of the rod body.

Thus, in the present invention, the cylindrical band portion of the dust cover is provided integrally adjacent the main body portion that surrounds the socket. The relatively large socket and the relatively small arm portion are surrounded by portion of the dust cover integrally provided adjacent the main body portion, and the dust cover is thereby held with the socket and the arm portion inside it.

This means that holding and fixing the dust cover in position does not require a fastener or the like; no such separate component is required for the new dust cover as compared with the prior case. Since the dust cover has an opening through which the main body portion receives the ball head portion of the ball stud, the ball head portion can be fitted into the socket along with the cover, and the ball joint can be completed while equipped with the cover.

Since the band portion has the connection portion between the base end of the arm portion and the first end of the cylinder body, or the collar portion that covers the connection portion between the base end of the arm portion and the distal end of the rod body, when both are connected by welding or by screwing them together, the covering function can be performed by the collar portion at the welded portion or at the location of the screw connection.

### BRIEF DESCRIPTION OF THE DRAWINGS

The present invention will be described below in connection with the appended drawings, in which:

FIGS. 1(a), 1(b), and 1(c) provide views of a gas spring equipped with a dust cover according to the present invention; and

FIGS. 2(a) and 2(b) illustrate a ball joint.

### DETAILED DESCRIPTION OF PREFERRED EMBODIMENTS

The gas spring equipped with the dust cover according to the present invention is for a rear door or a seat back of a vehicle, with one end of the gas spring connected to a fixed element and the other end connected to a movable element. The gas spring may serve as a source power for the movable side, as an auxiliary power source, or as a status maintaining device for the movable side, for example.

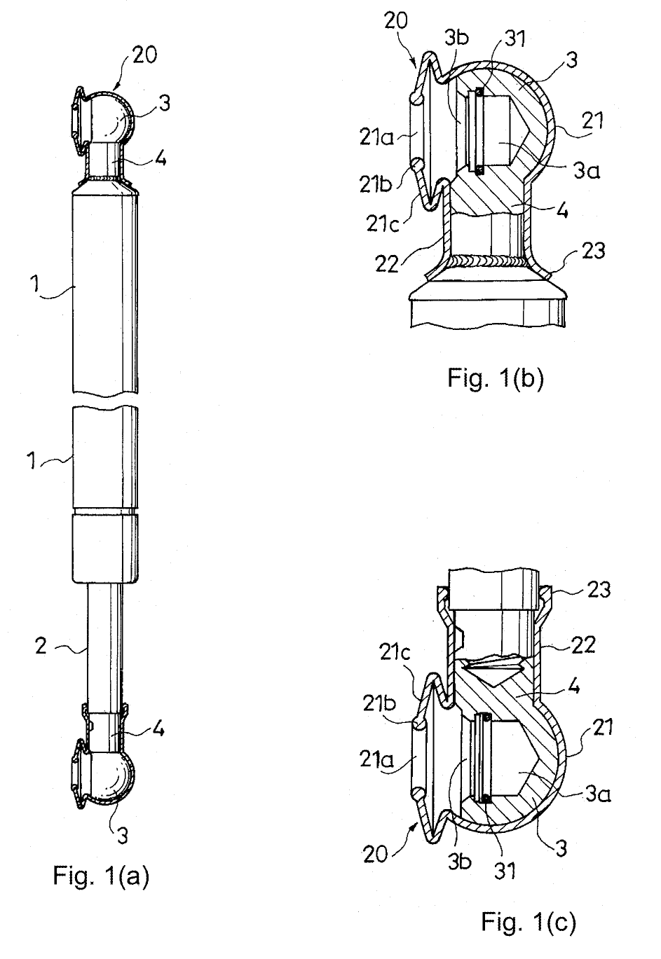

The gas spring illustrated in FIGS. 1(a), 1(b), and 1(c) includes a rod body 2 that is movable into and out of a cylinder body 1. The cylinder body contains a gas sealed inside it at a predetermined pressure. A socket 3 forms a part of a ball joint at one end of the cylinder body 1 at the upper side of FIG. 1(a). Another such socket 3 forms a part of a ball joint at a distal end of a rod body 2 at the upper side of FIG. 1(a).

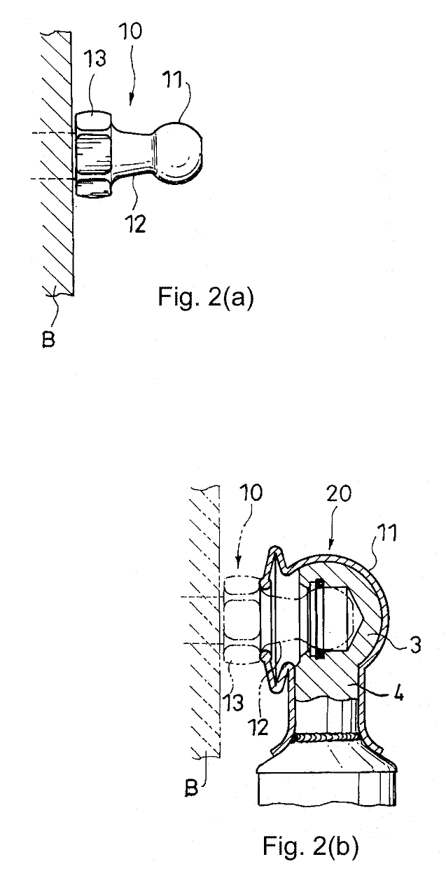

The socket 3, as FIGS. 2(a) and 2(b) indicate, receives a ball head portion 11 of a ball stud 10 (shown in phantom lines in FIG. 2(b). The ball stud is fitted into the socket so that the ball stud and the socket are connected for rotation with respect to one another.

The ball stud 10 is, as is indicated in FIG. 2(a), fixed to a car body or a rear door B of a vehicle, while the ball stud 10 is separated from the socket 3.

When sockets 3 are provided at a first end of the cylinder body 1 and at the distal end of the rod body 2, the sockets 3 are located adjacent to arm portions 4 that are formed integrally with the sockets 3.

In the figures, the arm portion 4 is made integral to the end of the cylinder body 1 by welding (see FIG. 1(b), and screwed onto the distal end of the rod body 2 (see FIG. 1(c).

Each socket 3 has a hole 3a as is shown in FIGS. 1(b) and 1(c). The ball stud 10 has a ball head portion 11 at the location of this hole 3a (see FIG. 2(a)). A snap ring 31 is provided at an inner circumference of an opening end portion at the left side of FIG. 1(a) or 1(b), that is, at an opening 3b of the hole 3a.

The snap ring 31 has a small diameter on an outer side at the left side in the figures at the opening 3b of the hole 3a, and is contained in an annular groove in two front and rear stages which include a large diameter on an inner side at the right side in the figures.

When the ball head portion 11 is fitted into the hole 3a through the opening 3b, the snap ring 31 allows passage of the ball head portion 11 through the snap ring in a large-diameter annular groove. When the ball head portion 11 contained in the hole 3a moves to exit the hole 3a, the snap ring 31 moves to the small-diameter annular groove so as to prevent passage of the ball head portion 11 and thereby to prevent removal of the ball head portion 11 from the hole 3a.

With the ball joint shown in the figures, when the gas spring is distributed as a product, the ball stud 10 is distributed along with the gas spring as a set, but the ball joint is not then fitted inside the socket 3.

The ball stud 10 includes, as is shown in FIGS. 2(a) and 2(b), the ball head portion 11, a stud portion 12 in the form of a shaft portion integral with the ball head portion 11, and a mounting portion 13 integral with the stud portion 12. The mounting portion 13 enables connection of the ball stud 10 to the car body or rear door B in the vehicle.

A dust cover 20 of the present invention is formed of an elastic rubber material or a soft synthetic resin material. As FIGS. 1(b) and 1(c) show, the dust cover includes a main body portion 21, a band portion 22, and a collar portion 23.

The main body portion 21 of the dust cover 20 surrounds the socket 3 from the outside, that is, from the bottom side to be the right side in the figures, on the side away from the opening 3b.

The main body portion 21 has an opening 21a at the left side of the figures, through which the ball head portion 11 of the ball stud 12 is received. The cover includes an O-ring shaped portion 21b at the inner circumference of the opening 21a The O-ring shaped portion 21b surrounds and fastens the cover at the stud portion 12 adjacent the ball head portion 11 of the ball stud 10 (see the phantom line depiction of FIG. 2(b)).

The main body portion 21 preferably contains the socket 3 inside the main body portion 21 without a gap between them, but in order to enable use of the cover with sockets having different outer diameters, a gap may instead be present between the outer circumference of the socket 3 and the inner circumference of the main body portion 21.

A flexed portion 21c between the main body portion 21 and the O-ring shaped portion 21b of the dust cover 20 allows for some movement of the stud portion 12 when the ball head portion 11 rotates inside the socket 3.

A cylindrical band portion 22 is formed integral to the main body portion 21 of the dust cover 20. The band portion 22 surrounds the arm portion 4 adjacent to the socket 3 with the inner circumference of the band portion 22 in close contact with the outer circumference of the arm portion 4.

The socket 3 of the ball joint is somewhat larger than the arm portion 4, and thus the main body portion 21 of the dust cover 20 is accordingly larger than the arm portion 22.

The band portion 22 further includes an integral collar portion 23, which will be described later. Since the band portion is formed integrally with the main body portion 21, when the dust cover 20 is installed over the socket 3 and the arm portion 4, the diameter of the band portion 22 is expanded and the socket 3 is inserted then inserted through the band portion. The diameter of the band portion 22 can then close so that the band portion is brought into close contact with the arm portion 4.

Since the diameter of the band portion 22 is reduced after the socket 3 is inserted through it, the band portion thus inherently functions to retain the parts together. Since it is not inevitable that the inner circumference of the band portion 22 be brought into actual close contact with the outer circumference of the arm portion 4 in its normal state, as long as its diameter is reduced after expansion, the band portion 22 does not have to be in close contact with the arm portion 4. Some gap may instead remain between these parts.

Moreover, in this dust cover 20, the collar portion 23 is provided integrally with the band portion 22, and for that reason, the diameter of the collar portion is also expanded when the diameter of the band portion 22 is expanded.

Thus, even in this collar portion 23, since the diameter of the collar portion is reduced after expansion, the inner circumference of the collar portion is brought into close contact with a welded portion between the bottom end of the cylinder body 1 and the arm portion 4 similarly to the above-mentioned band portion 22, and also, the inner circumference is brought into close contact with a screw attachment between the distal end of the rod body 2 and the arm portion 4.

The dust cover 20 of the present invention covers not only the connection portion between the socket 3 in the ball joint and the ball head portion 11 fitted in the socket 3, but the arm portion 4 integrally provided adjacent to the socket 3 is also surrounded by the band portion 22. The welded portion or screwed portion adjacent the arm portion 4 is also integrally surrounded by the collar portion 23.

Thus, a single component can be used as a cover for all of these elements, and the required number of parts is thereby reduced. This contributes to a reduction of the number of parts in the assembly, assembly of these parts is made easier, and less labor is required to perform the work. The appearance of the resulting assembly is, moreover, not displeasing, and the cover will be expected to provide effective cover and protection for the parts inside it.

In the above, the O-ring shaped portion 21b that forms the opening 21a in the main body portion 21 that surrounds the socket 3 provides a fastening margin with respect to the stud portion 12 of the ball stud 10, but instead of that or in addition to that, the O-ring shaped portion 21b may be brought into close contact with the mounting portion 13 in the ball stud 10 (see the phantom line diagram in FIG. 2(b)).

And in the above, in the dust cover 20, the band portion 22 or the collar portion 23 may be maintained in close contact to a corresponding portion by means of a sealant or an adhesive.

What is claimed is:

1. A dust cover surrounding a socket provided at a first end of a cylinder body in a gas spring inside of which a gas is sealed or at a distal end of a rod body to be inserted into and movable in and out of the cylinder body wherein the socket has a ball head portion of a ball stud fitted into the socket, wherein a main body portion of the dust cover surrounds the socket, wherein a cylindrical band portion that is integral with and adjacent to the main body portion surrounds an arm portion that is integral with and adjacent to the socket, wherein the main body portion has an opening for receiving the ball head portion of the ball stud, wherein the band portion includes a connection portion between a base end of the arm portion and a bottom end of the cylinder portion or a collar portion that covers the connection portion between the base end of the arm portion and the distal end of the rod body.

2. The dust cover according to claim 1, wherein the dust cover is formed of an elastic rubber material or a soft synthetic resin material so that insertion of the socket is allowed by diameter expansion of the band portion and the collar portion, and wherein the diameters are reduced after that insertion.

3. The dust cover according to claim 1 or 2, wherein the opening in the main body portion has an O-ring shaped portion, and wherein the O-ring shaped portion establishes a fastening margin with respect to the stud portion provided adjacent the ball head portion of the ball stud.
